(19) United States
(12) Patent Application Publication
(10) Pub. No.: US 2004/0264472 A1
(43) Pub. Date: Dec. 30, 2004

(54) Method and system for open-loop congestion control in a system fabric

(76) Inventors: Neal C. Oliver, Florham Park, NJ (US); David W. Gish, Riverdale, NJ (US); Gerald Lebizay, Madison, NJ (US); Henry Mitchel, Wayne, NJ (US); Brian Peebles, Cranford, NJ (US); Alan Stone, Morristown, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/607,728

(22) Filed: Jun. 27, 2003

(51) Int. Cl. H04L 12/28

(52) U.S. Cl. 370/395.4

(57) ABSTRACT

A method and system for open-loop congestion control in a system fabric is described. The method includes determining which traffic class each received network packet belongs, determining a path to be taken by each packet through a switch fabric, classifying each packet into one of a plurality of flow bundles based on the packet's destination and path through the switch fabric, mapping each packet into one of a plurality of queues to await transmission based on the flow bundle to which the packet has been classified, and scheduling the packets in the queues for transmission to a next destination through the switch fabric.

### BACKGROUND

1. Technical Field

Embodiments of the invention relate to the field of network congestion control, and more specifically to open-loop congestion control in a system fabric.

2. Background Information and Description of Related Art

Congestion control is the process by which traffic sources are regulated so as to avoid or recover from traffic overload conditions within a network. One method of congestion control is to provide feedback from a congestion point to the source of congestion. This requires a feedback mechanism that may be difficult to implement for a given network technology and set of system requirements. Another method of congestion control is to predetermine the characteristics of a traffic flow to develop a traffic spec that will prevent congestion and then regulate the traffic to comply with the traffic spec. However, standardizing this traffic spec for various networks is difficult.

### BRIEF DESCRIPTION OF DRAWINGS

The invention may best be understood by referring to the following description and accompanying drawings that are used to illustrate embodiments of the invention. In the drawings:

FIG. 1 is a block diagram illustrating one generalized embodiment of a system incorporating the invention.

FIG. 2 is a block diagram illustrating one generalized embodiment of a system incorporating the invention in greater detail.

FIG. 3 illustrates a hardware architecture of a network node according to one embodiment of the invention.

FIG. 4a illustrates an interconnection of nodes in a multishelf configuration using an external switch according to one embodiment of the invention.

FIG. 4b illustrates an interconnection of nodes in a multishelf configuration using a mesh according to one embodiment of the invention.

FIG. 5 is a flow diagram illustrating a method according to an embodiment of the invention.

### DETAILED DESCRIPTION

Embodiments of a system and method for open-loop congestion control in a system fabric are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

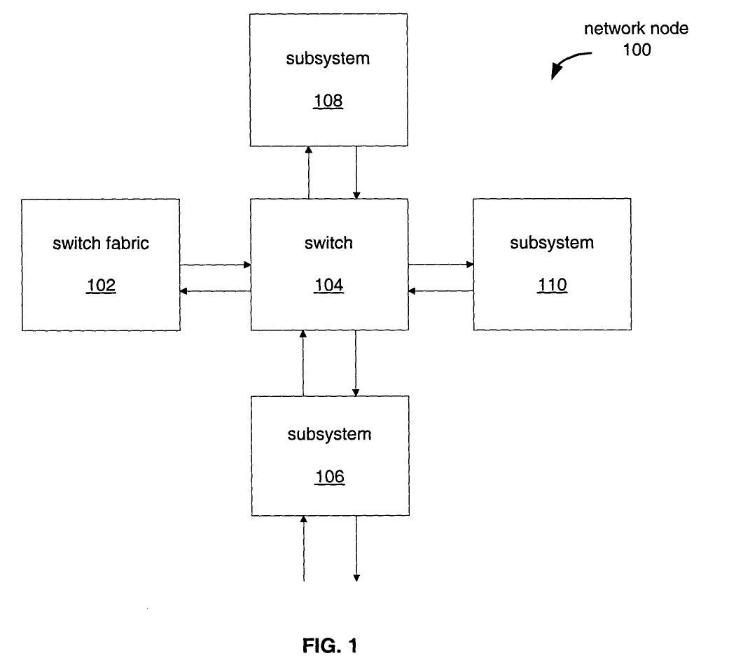

Referring to FIG. 1, a block diagram illustrates a network node 100 according to one embodiment of the invention. Those of ordinary skill in the art will appreciate that the network node 100 may include more components than those shown in FIG. 1. However, it is not necessary that all of these generally conventional components be shown in order to disclose an illustrative embodiment for practicing the invention.

Network node 100 includes a switch 104 to couple to a switch fabric 102 and a plurality of subsystems, such as 106, 108, and 110. The subsystem 106 is a subsystem at which external traffic, such as ATM virtual circuits, SONET, and Ethernet, enters and exits the network node 100. The subsystem 108 labels each received external packet to identify an associated flow, determines a path to be taken by each packet through the switch fabric, and classifies each packet into one of a plurality of flow bundles based on the packet's destination and path through the switch fabric 102. The subsystem 110 receives labeled and classified packets, maps each packet into the appropriate queue based on the flow bundle to which the packet has been classified, schedules the packets from each queue for transmission, and encapsulates the packets to form frames of uniform size before transmitting the packets to the switch fabric 102 through switch 104.

In one embodiment, the network node 100 also includes one or more adjunct subsystems that perform various high-touch processing functions, such as deep packet inspection and signal processing. A packet may be routed to an internal or external adjunct subsystem for processing. An adjunct process may be a thread of a network processor core, a thread of a network processor microengine, or a thread of an adjunct processor, such as a digital signal processor (DSP). The adjunct process may be on a local node or an external node.

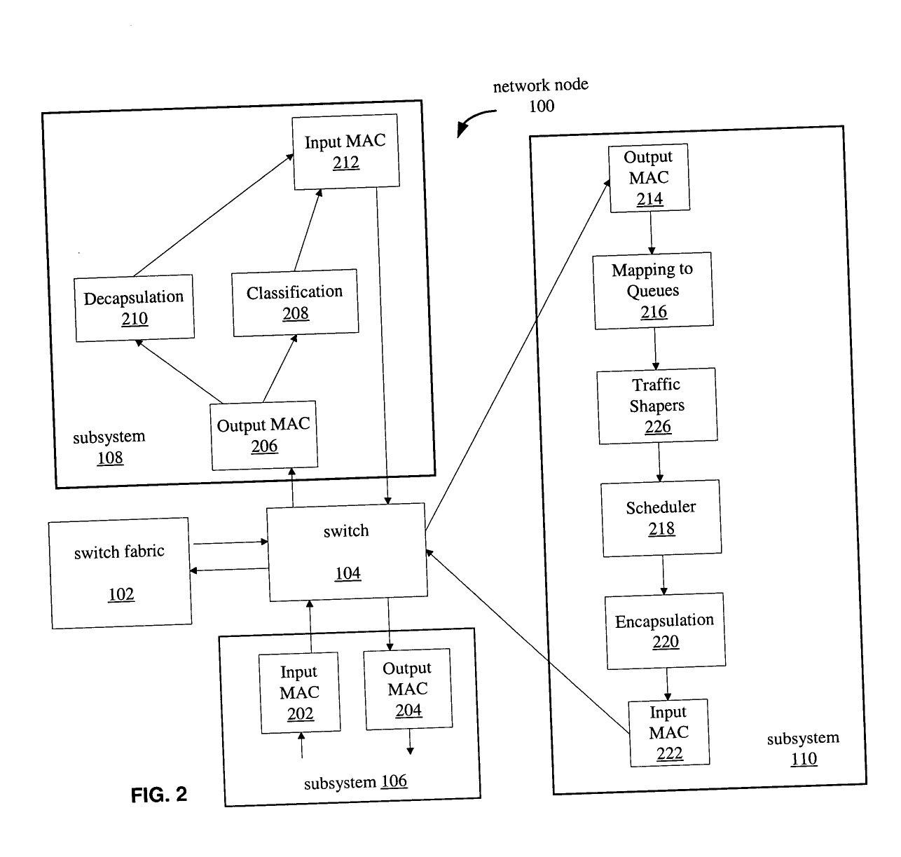

Although the exemplary network node 100 is shown in FIG. 1 and FIG. 2 as including a switch 104 to connect the subsystems and the switch fabric, in one embodiment, the switch 104 could be split into two switches. One of the two switches would be a local switch that connects the various subsystems of the network node. The other of the two switches would be a fabric switch that connects one or more subsystems to the switch fabric.

FIG. 2 illustrates the subsystems of network node 100 in greater detail according to one embodiment of the invention. As shown, subsystem 106 includes an input Media Access Control (MAC) 202 and an output MAC 204 to interface with external networks, such as ATM virtual circuits, SONET, and Ethernet. The subsystem 106 converts incoming data to packet streams, and formats and frames outbound packet streams for the network interface.

The subsystem 108 includes an input MAC 212, an output MAC 206, a classification function 208, and a decapsulation function 210. If an encapsulated frame is received at subsystem 108 from the switch fabric, it is sent to the decapsulation function 210, where the frame is decapsulated into the original packets. If an external packet is received at subsystem 108, then the external packet is sent to the classification function 208 to be labeled and classified.

The classification function 208 examines each external packet and gathers information about the packet for classification. The classification function 208 may examine a packet's source address and destination address, protocols associated with the packet (such as UDP, TCP, RTP, HTML, HTTP), and/or ports associated with the packet. From this information, the classification function 208 determines a particular flow associated with the packet and labels the packet with a flow identifier (ID) to identify the associated flow. The packet may then be classified into one of a plurality of traffic classes, such as voice, email, or video traffic. A path to be taken by the packet through the switch fabric is determined. Load balancing is considered when determining the paths packets will take through the switch fabric. Load balancing refers to selecting different paths for different flows to balance the load on the paths and to minimize the damage that could be done to throughput by a partial network failure.

Packets are classified into one of a plurality of flow bundles, where each packet of a flow bundle has the same destination and path through the network. In one embodiment, each packet of a flow bundle also has the same priority. In one embodiment, packets may be further edited by removing headers and layer encapsulations that are not needed during transmission through the system. After a packet is labeled and classified, it is sent back to switch 104 to be routed to subsystem 110.

The subsystem 110 includes an output MAC 214, an input MAC 222, a mapping element 216, traffic shapers 226, a scheduler 218, and an encapsulation element 220. The mapping element 216 examines each packet and determines which one of a plurality of queues the packet belongs based on the flow bundle to which the packet has been classified. The packet is then queued into the appropriate queue to await transmission to a next destination through the switch fabric. All packets in a queue belong the same flow bundle. Therefore, packets of a queue have a common destination and common path through the network. In one embodiment, packets of a queue also have a common priority. The scheduler 218 schedules the packets in the queues for transmission. The scheduler 218 uses various information to schedule packets from the queues. This information may include occupancy statistics, flowspec information configured via an administrative interface, and feedback from switch function. Various algorithms may be used for the scheduling, such as Longest Delay First, Stepwise QoS Scheduler (SQS), Simple Round Robin, and Weighted Round Robin.

Traffic shapers 226 are used to regulate the rate at which packets move out of the queues. Various algorithms may be used for traffic shaping, such as the token bucket shaper. In general, the traffic shaping spec specifies parameters, such as mean and peak traffic rates, to which the traffic from each queue should conform.

After the packets have been dequeued and scheduled for transmission, the scheduler 218 sends the packets to the encapsulation element 220. The encapsulation element 220 transforms the scheduled packets into uniform size frames by aggregating small packets and segmenting large packets. The size of the frame may be determined by the Message Transfer Unit (MTU) of the switch fabric technology used in the system. Small packets may be merged together using multiplexing, while large packets may be divided up using segmentation and reassembly (SAR). The encapsulation also includes conveyance headers that contain information required to decode the frame back into the original packets. The headers may also include a sequence number of packets within a frame to aid in error detection and a color field to indicate whether a flow conforms with its flowspec.

The encapsulated frames are sent to input MAC 222, which translates each frame into a format consistent with the switch fabric technology, and then sends each frame to a switch fabric port consistent with the path selected for the frame. Different switch fabric technologies and implementations may be used in the system, including Ethernet, PCI-Express/Advanced Switching, and InfiniBand technologies.

The following is an example of a path through the network node 100 taken by an external packet received at subsystem 106. The external packet is received from an external network at the input MAC 202 in subsystem 106. The packet is sent to switch 104, which forwards the packet to subsystem 108 for classification. The packet arrives at MAC 206 in subsystem 108, which forwards the packet to the classification function 208. The classification function 208 examines the packet, determines a flow associated with the packet, labels the packet with a flow ID, determines a path to be taken by the packet through the switch fabric, and classifies the packet into one of a plurality of flow bundles based on the packet's destination and path through the switch fabric. The labeled and classified packet is then sent to MAC 212, which forwards the packet back to switch 104. The switch 104 sends the packet to subsystem 110. The packet arrives at MAC 214 in subsystem 110, which forwards the packet to the mapping element 216. The mapping element 216 examines the packet's label identifiers and determines which queue the packet belongs based on the flow bundle to which the packet has been classified. The packet is then queued into the appropriate queue to await transmission to a next destination through the switch fabric. The scheduler 218 schedules the packet in the queue for transmission. The traffic shapers 226 ensure that traffic flowing out of each queue conforms to the configured specification and that predetermined traffic rates are not exceeded. When the packet is scheduled for transmission and dequeued, the packet is encapsulated by the encapsulation function 220 into a uniform size frame by aggregating the packet with other packets if the packet is small or segmenting the packet if the packet is large. The frame is then sent to the MAC 222, which translates the frame into a format consistent with the switch fabric technology, and then sends the frame to a switch fabric port consistent with the path selected for the frame. The packet may then arrive at another network node similar to the one from which it was transmitted.

The following is an example of a path through the network node 100 taken by a frame received from the switch fabric 102. The frame is received at the switch 104. The frame is then sent to the MAC 206 in subsystem 108, which forwards the packet to the decapsulation function 210. The decapsulation function 210 decapsulates the frame into the original one or more packets. The packets are then sent back to the switch 104 to be forwarded locally or externally. For example, the switch may send the packet to an adjunct subsystem for high touch processing or to subsystem 106 to be transmitted to an external network.

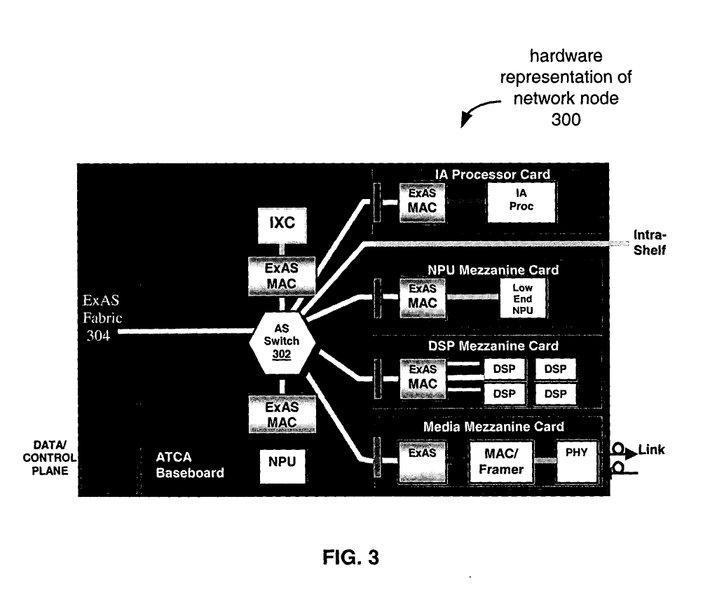

FIG. 3 illustrates a hardware representation of a network node 300 according to one embodiment of the invention. The center of the node is a switch 302 that connects the node to the rest of the network via the switch fabric 304 and to various processing elements located on a baseboard and mezzanine boards. A PCI-Express/Advanced Switching Node is used in this exemplary implementation. However, other network technologies, such as Ethernet, and InfiniBand technologies may be used in the network node in other embodiments. In one embodiment, subsystem 106 and an external adjunct subsystem may be located on mezzanine boards while subsystems 108 and 110 and an internal adjunct subsystem are located on the baseboard.

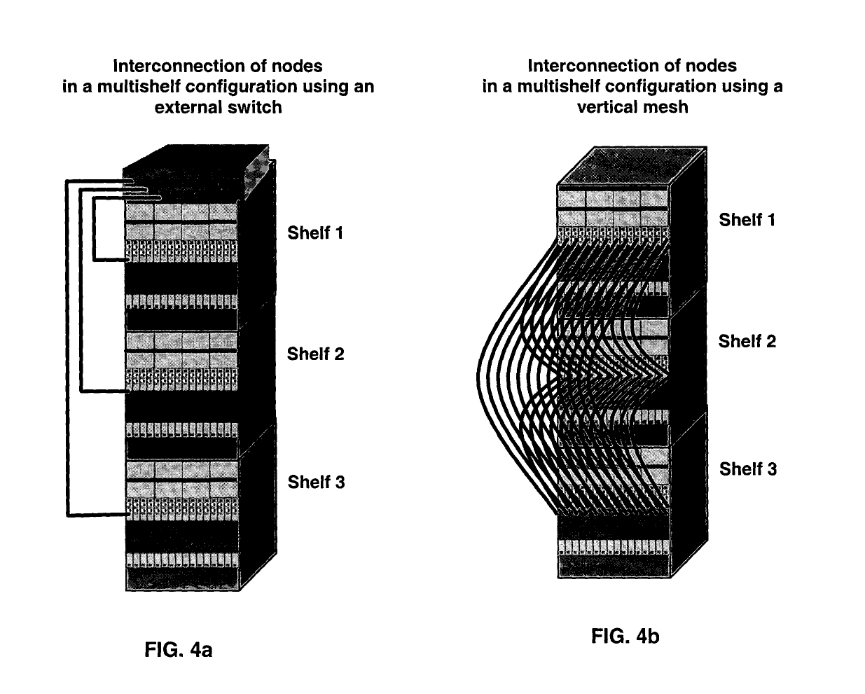

FIG. 4a illustrates how a network node may be interconnected in a scalable system to additional switching nodes in a network according to one embodiment of the invention. FIG. 4b illustrates how a network node may be interconnected in a scalable system with individual boards connected directly in a mesh according to one embodiment of the invention. Every board need not be connected vertically, and other mesh arrangements may be used to connect the boards in other embodiments of the invention.

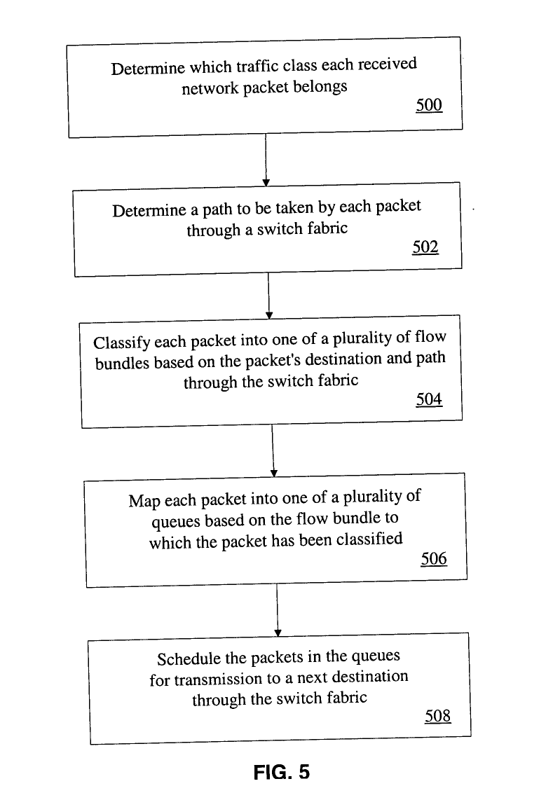

FIG. 5 illustrates a method according to one embodiment of the invention. At 500, a determination is made as to which traffic class each received network packet belongs. In one embodiment, the traffic class to which a packet belongs is determined based on factors including the protocols associated with the packet. At 502, a path to be taken by each packet through a switch fabric is determined. In one embodiment, one consideration for the determination of the path to be taken by each packet is load balancing. At 504, each packet is classified into one of a plurality of flow bundles based on the packet's destination and path through the switch fabric. In one embodiment, the flow bundle classification is also based on a packet's priority. In one embodiment, each packet is labeled with information identifying an associated flow and flow bundle. At 506, each packet is mapped into one of a plurality of queues to await transmission based on the flow bundle to which the packet has been classified. At 508, the packets in the queues are scheduled for transmission to a next destination through the switch fabric. The packets may be scheduled for transmission using various algorithms, such as longest delay first or round robin algorithms. In one embodiment, the rate at which traffic moves out the queues is regulated with a traffic shaping algorithm. In one embodiment, the packets are forwarded to a switch coupled to the switch fabric for transmission to the next destination.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
determining which traffic class each received network packet belongs;
determining a path to be taken by each packet through a switch fabric;
classifying each packet into one of a plurality of flow bundles based on the packet's destination and path through the switch fabric;
mapping each packet into one of a plurality of queues to await transmission based on the flow bundle to which the packet has been classified; and
scheduling the packets in the queues for transmission to a next destination through the switch fabric.

2. The method of claim 1, further comprising regulating the rate at which traffic moves out of the queues with a traffic shaping algorithm.

3. The method of claim 1, wherein determining a path to be taken by each packet through a switch fabric comprises determining a path to be taken by each packet through a switch fabric based on load balancing.

4. The method of claim 1, further comprising labeling each packet with information identifying an associated flow and flow bundle.

5. The method of claim 1, wherein classifying each packet into one of a plurality of flow bundles comprises classifying each packet into one of a plurality of flow bundles based on the packet's destination, path through the switch fabric, and priority.

6. The method of claim 1, wherein scheduling the packets in the queues for transmission comprises scheduling the packets in the queues for transmission using a Round Robin scheduling algorithm.

7. The method of claim 1, wherein scheduling the packets in the queues for transmission comprises scheduling the packets in the queues for transmission using a Longest Delay First algorithm.

8. The method of claim 1, wherein scheduling the packets in the queues for transmission comprises scheduling the packets in the queues for transmission using a Stepwise QoS Scheduler (SQS).

9. The method of claim 1, wherein determining which traffic class each received network packet belongs comprises determining which traffic class each received network packet belongs based on protocols associated with the packet.

10. The method of claim 1, further comprising forwarding the packets to a switch coupled to the switch fabric for transmission to the next destination.

11. An apparatus comprising:
a classification unit to examine packets received from a network, determine a path to be taken by each packet through a switch fabric, and classify each packet into one of a plurality of flow bundles based on the packet's destination and path through the switch fabric;
a mapping unit coupled to the classification unit to place each packet into one of a plurality of queues based on the flow bundle to which the packet has been classified;
one or more traffic shapers coupled to the mapping unit to regulate the rate at which traffic moves out of the queues; and
a scheduler coupled to the traffic shapers to regulate the order in which packets in the queues will be transmitted to a next destination through the switch fabric.

12. The apparatus of claim 11, further comprising an access unit coupled to the classification unit to receive packets from and transmit packets to the network.

13. The apparatus of claim 11, further comprising a switch coupled to the scheduler to transmit the scheduled packets to the switch fabric.

14. The apparatus of claim 11, wherein the classification unit comprises a load balancing element to determine a path to be taken by each packet through a switch fabric based on load balancing.

15. The apparatus of claim 11, wherein the classification unit comprises a labeling element to label each packet with information identifying an associated flow and flow bundle.

16. An article of manufacture comprising:
a machine accessible medium including content that when accessed by a machine causes the machine to:
determine a path to be taken by each received network packet through a switch fabric;
classify each packet into one of a plurality of flow bundles based on the packet's destination and path through the switch fabric;
map each packet into one of a plurality of queues to await transmission based on the flow bundle to which the packet has been classified; and
schedule the packets in the queues for transmission to a next destination through the switch fabric.

17. The article of manufacture of claim 16, wherein the machine-accessible medium further includes content that causes the machine to regulate the rate at which traffic moves out of the queues using a traffic shaping algorithm.

18. The article of manufacture of claim 16, wherein the machine-accessible medium further includes content that causes the machine to label each packet with information identifying an associated flow and flow bundle.

19. The article of manufacture of claim 16, wherein the machine-accessible medium further includes content that causes the machine to determine which traffic class each received network packet belongs.

20. The article of manufacture of claim 16, wherein the machine accessible medium including content that when accessed by the machine causes the machine to determine a path to be taken by each received network packet through a switch fabric comprises machine accessible medium including content that when accessed by the machine causes the machine to determine a path to be taken by each received network packet through a switch fabric based on load balancing.

21. The article of manufacture of claim 16, wherein the machine accessible medium including content that when accessed by the machine causes the machine to classify each packet into one of a plurality of flow bundles comprises machine accessible medium including content that when accessed by the machine causes the machine to classify each packet into one of a plurality of flow bundles based on the packet's destination, path through the switch fabric, and priority.

22. The article of manufacture of claim 16, wherein the machine-accessible medium further includes content that causes the machine to forward the packets to a switch coupled to the switch fabric for transmission to the next destination.

23. A system comprising:
a switch to receive and transmit packets;
a classification unit to examine packets received from a network through the switch, determine a path to be taken by each packet through a switch fabric, and classify each packet into one of a plurality of flow bundles based on the packet's destination and path through the switch fabric;
a mapping unit coupled to the classification unit to place each packet into one of a plurality of queues based on the flow bundle to which the packet has been classified;
a scheduler coupled to the mapping unit to regulate the order in which packets in the queues will be transmitted to a next destination; and
a switch fabric coupled to the switch via which scheduled packets are transmitted to the next destination.

24. The system of claim 23, further comprising one or more traffic shapers coupled to the scheduler to regulate the rate at which traffic moves out of the queues.

25. The system of claim 23, wherein the classification unit comprises a load balancing element to determine a path to be taken by each packet through the switch fabric based on load balancing.

26. The system of claim 23, wherein the classification unit comprises a labeling element to label each packet with information identifying an associated flow and flow bundle.
